(19) United States
(12) Patent Application Publication
(10) Pub. No.: US 2017/0320618 A1
(43) Pub. Date: Nov. 9, 2017

(54) ODOR-PROOF CONTAINER FOR PERSONAL ITEMS

(71) Applicant: Noah Shopsowitz, Toronto (CA)

(72) Inventor: Noah Shopsowitz, Toronto (CA)

(21) Appl. No.: 15/495,453

(22) Filed: Apr. 24, 2017

Related U.S. Application Data
(60) Provisional application No. 62/326,321, filed on Apr. 22, 2016.

(51) Int. Cl. B65D 6/06; A61J 1/00; B65D 6/00; B65D 81/20

(52) U.S. Cl. CPC B65D 11/12; B65D 81/2015; A61J 1/00; B65D 11/20; A61J 2205/60

(57) ABSTRACT

A portable, personal container is formed from an inner container formed by a first tube and a second tube which slidably engage to form a sealed inner container, which fits within an outer container formed by a first tube and a second tube which slidably engage to form a sealed outer container. A spring allows a pumping action which creates a slight negative pressure in the inner container and creates a plenum within the outer container, keeping odors and freshness in.

### FIELD OF THE INVENTION

The present invention relates to portable container which is substantially odor-proof and suitable for storing and carrying personal items such as pharmaceuticals, drugs or the like,

### BACKGROUND

Certain odiferous items such as drugs, pharmaceuticals, nutraceuticals or the like may be inconvenient to store and carry.

There remains a need in the art for a portable container which is odor-proof and allows convenient storage and transport of various personal items.

### BACKGROUND

In one aspect, the invention may comprise a portable, personal container which comprises:

(a) an inner container comprising a first tube and a second tube which mate to form an inner enclosure;

(b) an outer container comprising a first tube and a second tube which mate to form an outer enclosure, wherein the inner container is disposed within the outer container.

### BRIEF DESCRIPTION OF THE DRAWINGS

The drawings below form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1A shows a schematic cross-section representation of one embodiment of the present invention. FIG. 1B shows a pictorial representation of one embodiment. FIG. 1C shows a pictorial representation of the inner container of FIG. 1B.

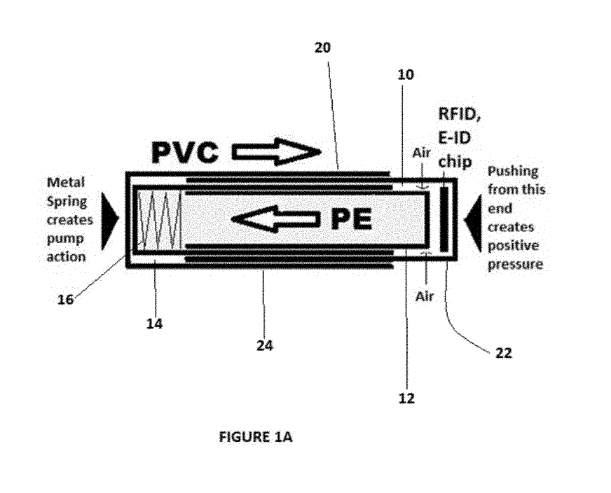

FIG. 2A shows a cross-section of one embodiment using a foam insert in the inner enclosure. FIG. 2B shows a cross-section of another embodiment a flexible spring profile in the inner enclosure.

FIG. 3 shows a cross-section of an inner enclosure of one embodiment have locking tabs.

FIG. 4 shows a cross-section of an inner enclosure of an alternative embodiment.

FIG. 5A shows a cross-section of an inner enclosure of another alternative embodiment. FIG. 5B shows a top plan view of the embodiment of FIG. 5A.

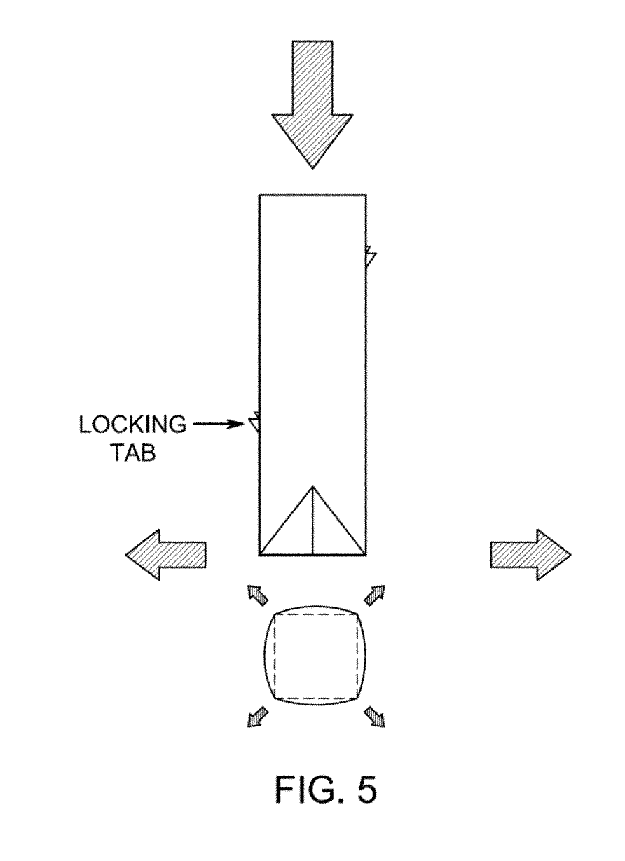

FIG. 6 shows a cross-sectional view of a childproof locking tab.

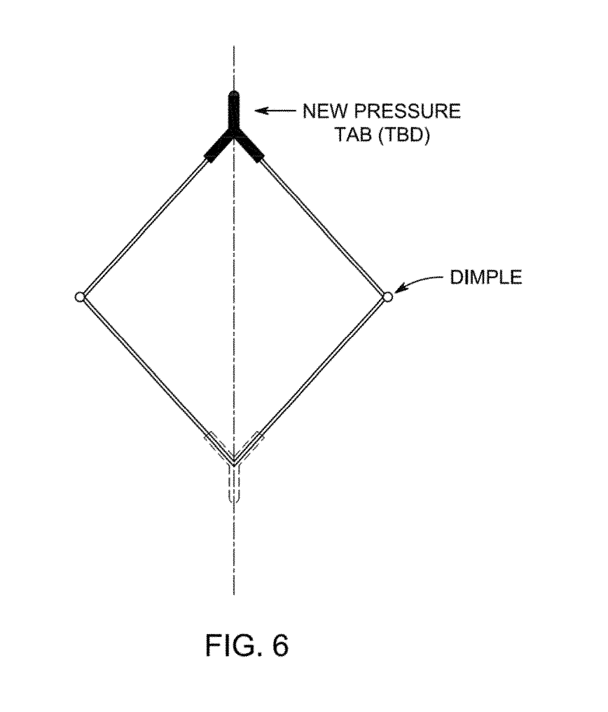

FIG. 7 shows a pictorial view of an inner container having locking and ratcheting tabs and dimples.

### DESCRIPTION

The present invention may comprise a portable, personal container which comprises:

(a) an inner container (10) comprising a first tube (12) and a second tube (14) which mate to form an inner enclosure;

(b) an outer container (20) comprising a first tube (22) and a second tube (24) which mate to form an outer enclosure, wherein the inner container is disposed within the outer enclosure.

In a preferred embodiment, the inner container (10) comprises a polymer which is substantially impervious to volatile organic compounds, such as a polyethylene. The outer container (20) may comprise a polymer which also is substantially impervious to volatile organic compounds, and which preferably comprises chloride groups.

Preferably, in some embodiments, the plastic wall thickness is sufficient to make the containers substantially crush-proof in ordinary use.

Embodiments of the invention use a combination of polyethylene (PE), which may comprise high density PE (HDPE), and polyvinylchloride (PVC) polymers to reduce or eliminate escape of volatile organic compounds (VOCs) from inside to outside, and to provide a self cleaning environment (PVC) that may guard against contamination of pockets, purses, and hands.

Accordingly, the container of the present invention may be particularly useful for storing and transporting substances which are associated with odors, such as various plant materials, pharmaceuticals, nutraceuticals or drugs. In particular, the container may be suitable for marijuana or components of cannabis plants such as hashish oil.

Further information regarding the polymers is presented below. The inner container is preferably constructed of polyethylene, which may be an opaque, and presents a substantial barrier for VOCs and water. The outer container is preferably constructed from transparent or translucent polyvinylchloride. PVC is a linear polymer having chloride groups on alternating carbon centres. PVC has mainly an atactic stereochemistry, which means that the relative stereochemistry of the chloride centres are random. Some degree of syndiotacticity of the chain gives a few percent crystallinity that is influential on the properties of the material. About 57% of the mass of PVC is chlorine. The presence of chloride groups gives the polymer very different properties from the structurally related material polyethylene.

The following table provide standard data for permeability of different polymers to moisture, oxygen and carbon dioxide, which may inform material choices for the inner and outer containers. As may be seen in the table, HDPE provides a good barrier against moisture vapor transmission, but is less effective against oxygen or carbon dioxide permeation.

| | | | | | | Re- |
|---|---|---|---|---|---|---|
| | | | | | Impact | cycle |
| Material | Clarity | MVTR* | O₂** | CO₂** | Strength | Code |
| PET (Oriented | Ex- | 2.0 | 75 | 540 | Good | 1 |
| or Stretch | cellent | | | | | |
| Blown | | | | | | |
| Polyethylene | | | | | | |
| Terephthalate) | | | | | | |
| HDPE (High | Poor | 0.5 | 4,000 | 18,000 | Good | 2 |
| Density | | | | | | |
| Polyethylene) | | | | | | |
| PVC | Good | 3.0 | 150 | 380 | Fair | 3 |
| (Polyvinyl | | | | | | |
| Chloride) | | | | | | |
| PP | Poor | 0.5 | 3,500 | 7,000 | Fair | 5 |
| (Polypropylene) | | | | | | |
| PS | Ex- | 10.0 | 6,000 | 18,700 | Poor | 6 |
| (Polystyrene) | cellent | | | | | |
| PLA | Very | 18-22 | 38-42 | 201 | Good | 7 |
| (Polylactide - | Good | | | | | |
| Oriented/Stretch | | | | | | |
| Blown bottles) | | | | | | |

In one embodiment, the inner container (10) may be spring (16) loaded to urge the first tube and second tube apart. In one embodiment, when the outer container (20) is closed by pushing the two tubes together, the inner container will compress slightly because the ends of the outer container bear on the ends of the inner container. When released, the spring will slightly expand the inner container, which at the same time will slightly expand the outer container. As a result, some of the air in the inner container will be refreshed with air from the outer container. This pump action of the internal spring mechanism circulates air inside the outer enclosure airspace to refresh the inner enclosure. There may also be some airspace within the outer container and outside the inner container, creating a plenum effect, when the entire container is assembled. In one embodiment, either or both of the inner container tubes may be bonded to the outer container tubes, preferably at the ends.

Furthermore, the pump action may result in a slight negative pressure in the inner container, caused by the rebound of the spring (16). This negative pressure may assist in preventing escape of odors from the inner container (10).

In an alternative embodiment, an engineered foam piece may act as the spring (16) that contracts when compressed and the action forces the internal air out and creates a positive seal and negative pressure (vacuum) in the interior chamber that keeps odors and moisture in.

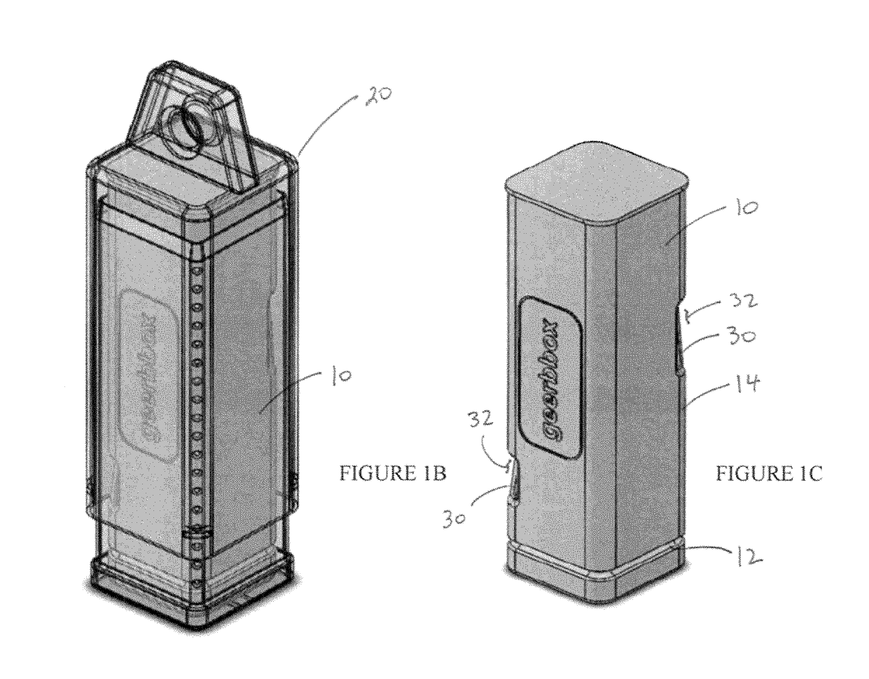

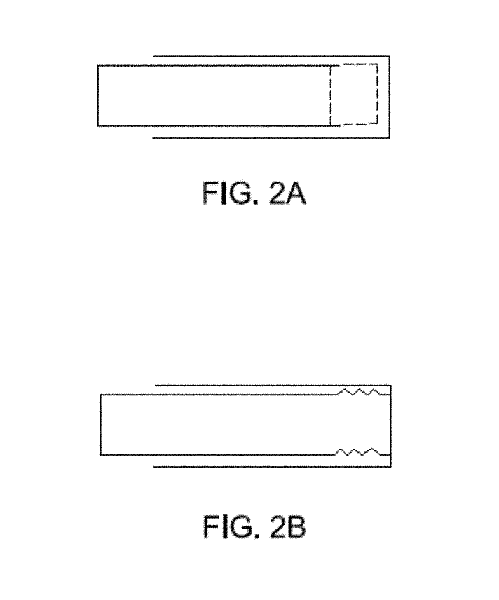

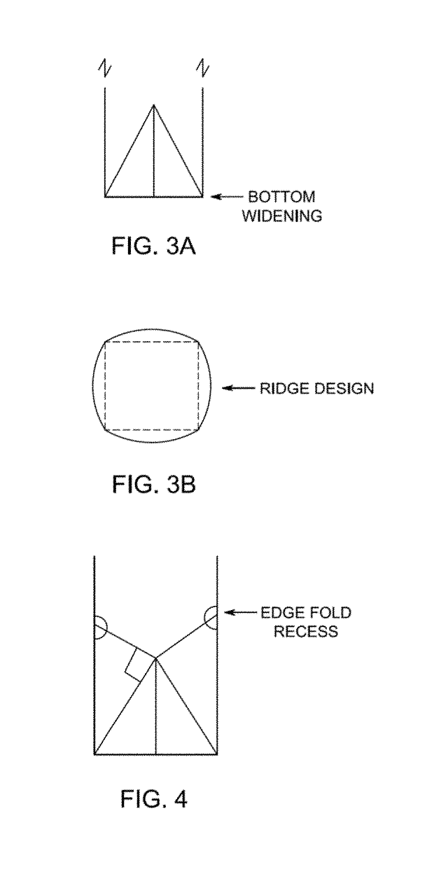

In another alternative, a spring mechanism may also be created by adapting the open end of the inner container (10) to have a design that acts spring-like. The open end may be configured to elastically deform when pressed against the closed end of the other tube. As shown in FIG. 2B, the open end may be configured with a thinner plastic to be flexible, and with a compressible “zig-zag” profile. Alternatively, one end of the inner container may be configured with a cone (17) to spread laterally under longitudinal pressure, as is shown in FIGS. 3A, 3B or 4.

As shown in FIG. 4, an edge fold recess (18) is a negative impression formed in the plastic material of the inside tube (12) to allow the plastic material to deform when depressed as part of the spring mechanism.

In some embodiments, the inner container (10) and/or the outer container (20) may be configured to maintain the container in a closed position, which may assist in keeping odours and moisture in and encouraging freshness of any materials inside the inner container. The containers may also be configured to include a child resistant feature that comprises a lock mechanism or a mechanism which makes opening more difficult for children. For example, tabs (30) on the inside tube (12) may protrude through openings (32) in the corresponding outer tube (14) to lock together. This child-resistant feature also serves to maintain the positive seal of the inner container (10) by maintaining the first and second tubes in a sealed position. The biasing force of the spring creates more friction between the tabs (30) in their openings to make opening more difficult for children.

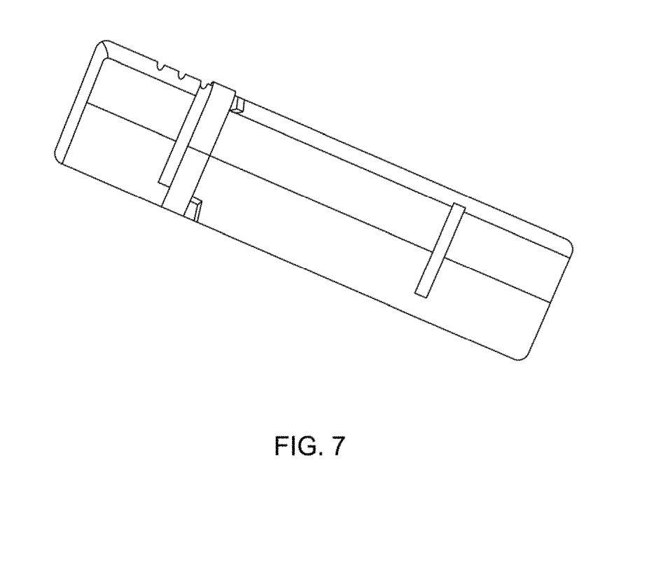

As shown in FIG. 7, in one embodiment, a series of dimples (34) may mate with a tab or tabs (36) to provide a ratcheting closing mechanism. This configuration may be a child-resistant feature, or may be used in addition to another child-resistant locking feature.

The size of the containers and the cross-sectional shape of the containers may be varied according to intended use. For example, the containers may be long enough to carry a of a marijuana cigarette. The cross-sectional shape may be circular, oval, polygonal or an eccentric shape. In one example, the containers have rectangular cross-sections with rounded corners. The outer container must be larger than the inner container by a degree which creates some airspace within the outer enclosure when the entire container is assembled.

The container may comprise a radiofrequency (RF) chip, such as an RFID or NFC chip which may be read or identified by a wireless scanner. The RF chip may be located at the lowest point or bottom when the unit is standing on its end (base). The RF chip may facilitate use as e-wallet or identification that would be useful at events with controlled entry, such as concerts or the like.

The container may comprise an attachment point for a lanyard, a keychain or the like. Additionally, the container presents easily branded surfaces for graphic images, such that the container may be provided as a promotional item.

One skilled in the art can ascertain the essential characteristics of this invention, and without departing from the scope thereof, can make various changes and modifications of the invention to adapt it to various usages and conditions. Thus, various modifications of the invention in addition to those shown and described herein will be apparent to those skilled in the art from the foregoing description. Such modifications are also intended to fall within the scope of the appended claims.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed,

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

The term “and/or” means any one of the items, any combination of the items, or all of the items with which this term is associated. The phrase “one or more” is readily understood by one of skill in the art, particularly when read in context of its usage.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

1. A portable, personal container which comprises:
(a) an inner container comprising a first tube and a second tube which slidably engage to form a sealed inner container;
(b) an outer container comprising a first tube and a second tube which slidably engage to form a sealed outer container, wherein the inner container is disposed within the outer container.

2. The container of claim 1 wherein the inner container comprises a spring disposed within the first tube which engages an open end of the second tube, to urge the first and second tubes apart.

3. The container of claim 2 wherein the spring comprises a compressible material.

4. The container of claim 3 wherein the compressible material comprises a solid foam.

5. The container of claim 2 wherein the spring comprises a deformable end of the second tube.

6. The container of claim 1 further comprising a locking tab disposed on the inner container first tube, which mates with an opening in the inner container second tube.

7. The container of claim 6 wherein the locking tab may be disengaged from an opening by deforming the inner container.

8. The container of claim 1 wherein the inner container comprises polyethylene or high density polyethylene and the outer container comprises polyvinyl chloride.

9. The container of claim 2 wherein a length of the inner container matches a length of the outer container, such that when the first and second tubes of the outer container are compressed together, the spring of the inner container is compressed.
